(19) United States
(12) Patent Application Publication
(10) Pub. No.: US 2004/0024656 A1
(43) Pub. Date: Feb. 5, 2004

(54) Interactive product selector with inferential logic engine

(76) Inventor: Kevin B. Coleman, Somerville, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 09/737,926

(22) Filed: Dec. 15, 2000

Related U.S. Application Data
(63) Continuation-in-part of application No. 09/615,177, filed on Jul. 13, 2000.
(60) Provisional application No. 60/209,228, filed on Jun. 2, 2000.

(51) Int. Cl. G06F 17/60; G06F 15/18

(52) U.S. Cl. 705/27; 706/1

(57) ABSTRACT

Methods and systems for an inferential logic engine (ILE) for an interactive product selector. In an embodiment, the interactive product selector provides a user with purchase decision questions (PDQs) regarding a product/service specified by the user. Subject matter experts familiar with the specified product/service can survey the potential user responses to PDQs, and based upon the responses, establish inferences. User selections or responses can be represented logically, and a user's selections satisfying a given logical expression can cause the ILE modify the page presentation. In an embodiment, the ILE can be integrated with a Fuzzy Logic Engine (FLE), wherein inferential information can provide additional input to an existing FLE, or can filter the outputs of an existing FLE.

### CLAIM OF PRIORITY

This application claims priority to and is a continuation-in-part to a U.S. application filed concurrently herewith, entitled “Interactive Product Selector With Fuzzy Logic Engine”, naming Kevin B. Coleman as inventor, the contents of which are herein incorporated by reference, and being a continuation-in-part to U.S. Ser. No. 09/615,177, entitled “Interactive Product Selector”, filed on Jul. 13, 2000, naming Kevin B. Coleman as inventor, the contents of which are herein incorporated by reference, wherein U.S. Ser. No. 09/615,177 further claims priority to U.S. Provisional Application 60/209,228, entitled “Interactive Product Selector”, filed on Jun. 2, 2000, and naming Kevin B. Coleman as inventor, the contents of which are also herein incorporated by reference.

### CROSS-REFERENCE TO RELATED APPLICATIONS

This patent application is co-pending with a related patent application entitled “Interactive Product Selector With Fuzzy Logic Engine” naming the same inventor as this patent application.

### BACKGROUND OF THE INVENTION

(1) Field of the Invention

This application relates to fuzzy logic, and more particularly, to an interactive, Web-based product selector that utilizes fuzzy logic to assist online shoppers or consumers with purchasing decisions.

(2) Description of the Prior Art

Online shopping for goods and services on the Internet, and its graphical offspring, the World Wide Web (“Web”), is growing at a tremendous rate. An increasing number of retailers, and more recently, manufacturers, offer products and service over the Internet. Furthermore, even when purchases are through more traditional “brick-and-mortar” retail outlets, consumers frequently research products online prior to the purchase event.

Various Web sites have been developed in an attempt to address online research and purchasing. In the case of manufacturer's direct sales through the Internet, one or more pages may be provided through which a consumer may specify product features. As a significant disadvantage, these sites constrain an online shopper to a single product source, i.e., the manufacturer. Other sites, such as “Active Buyer's Guide”, aggregate products from various sources within a category, and walk a consumer through a series of trade-offs between product features and costs. As a significant disadvantage, such sites force a consumer to explicitly weight importance of various feature selections, and require navigation through a series of separate HTML pages. This may significantly detract from the consumer's shopping experience since it is time consuming, and since it may burden a shopper with a series of difficult decisions.

There remains a need for an interactive product selector for use by consumers of goods and services that provides a positive user experience while providing valuable guidance to the user during a selection process.

### SUMMARY OF THE INVENTION

In accordance with the principles of the invention, there is provided an interactive product selector for assisting customers with purchasing decisions. A single page can be presented to a user that includes feature selections to be made by the user. A panel within the page may be dynamically updated to provided suggestions and guidance concerning each feature selection without requiring a new page to be transmitted to a client device. Further, a user session can be tracked, and fuzzy logic applied to include information about changes in feature selections so that this information can assist in generating a product set. The product set, which includes products satisfying user-specified criteria, can then be reviewed in detail. The product selection session can culminate in fulfillment of a customer order.

In one embodiment, fuzzy logic can assist in matching user preferences to products by measuring user requirements and associated changes in those requirements during a product selection process. A fuzzy logic embodiment can identify products most closely matching the product definition indicated by the consumer's explicit and implicit selection process actions.

In an embodiment, the disclosed methods and systems associate user-selected criteria on a page to products on the page by providing at least one user criterion with a selection scheme to a user, receiving the user's option selections, assigning membership grades to option selections based on order of the option selections, relating the option selections to products, and forming a master membership grade for the products based on the membership grades of the option selections related to the products. The user can then be presented with the products according to master membership grades, wherein in one embodiment, the highest master membership grade represents the product most closely matching the user's requirements. In an embodiment, the user criterion can be in the form of purchase decision questions that can be radio buttons or check-boxes.

In an embodiment, an inferential logic engine can be implemented that allows subject matter experts to program inferences into the system according to selections or options by a system user. Depending upon the user's selections, the methods and systems of the inferential logic engine can be activated to alter the page provided to the user. As a result of the inferential logic engine, the user's page can be better refined to the user's preferences. In an embodiment, the inferential logic engine can be configured to provide inputs to a fuzzy logic engine. In one embodiment, the inferential logic engine can filter or otherwise manage the outputs of the fuzzy logic engine. In an embodiment, the inferential logic engine can weight the outputs of the fuzzy logic engine.

### BRIEF DESCRIPTION OF THE DRAWINGS

The foregoing and other objects and advantages of the invention will be appreciated more fully from the following further description thereof, with reference to the accompanying drawings, wherein:

FIG. 1 shows a schematic diagram of the entities involved in an embodiment of a method and system disclosed herein;

FIG. 2 shows a block diagram of a preferred embodiment of a server;

FIG. 3 shows a home page according to the principles of the invention;

FIG. 4 shows a product selection page according to the principles of the invention;

FIG. 5 shows a product selection page according to the principles of the invention;

FIG. 6 shows a product set select ed according to the principles of the invention;

FIG. 7 shows a product set revision page according to the principles of the invention;

FIG. 8 shows a process for selecting products according to the principles of the invention; and

FIG. 9 shows a product set generation process according to the principles of the invention.

### DESCRIPTION OF THE ILLUSTRATED EMBODIMENTS

To provide an overall understanding of the invention, certain illustrative embodiments will now be described; however, it will be understood by one of ordinary skill in the art that the systems and methods described herein can be adapted and modified to provide systems and methods for other suitable applications and that other additions and modifications can be made to the invention without departing from the scope hereof. For example, the illustrated methods and systems include an online product selector for consumer products and an online product selector for financial products. However, it will be understood by those of ordinary skill in the art that the methods and systems described herein can be suitably adapted to other business categories such as insurance products, services, or any other business wherein a purchaser may select between a number of different products or services within a category. The methods and systems described herein are particularly suitable to those businesses where a consumer may require explanation or assistance in distinguishing between a number of options for a product feature. The terms “product” and “service”, as used herein, are intended to and shall be understood refer generally to products, goods and/or services, unless a particular meaning is otherwise specifically stated.

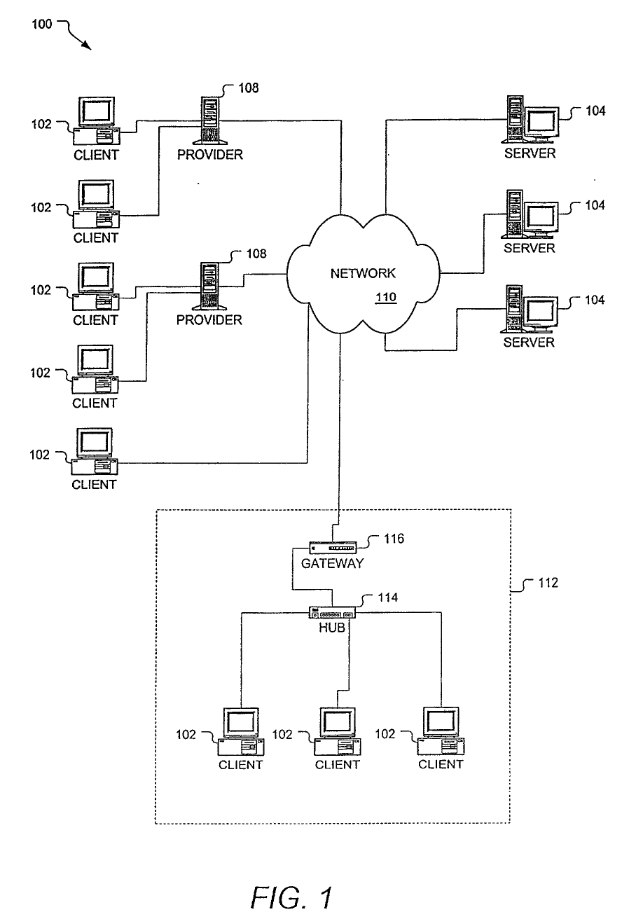

FIG. 1 shows a schematic diagram of the entities involved in an embodiment of a method and system disclosed herein. In a system 100, a plurality of clients 102, servers 104, and providers 108 are connected via an internetwork 110. It should be understood that any number of clients 102, servers 104, and providers 108 could participate in such a system 100. The system may further include one or more local area networks (“LAN”) 112 interconnecting clients 102 through a hub 114 (in, for example, a peer network) or a local area network server 114 (in, for example, a client-server network). The LAN 112 may be connected to the internetwork 110 through a gateway 116, which provides security to the LAN 112 and ensures operating compatibility between the LAN 112 and the internetwork 110.

In one embodiment, the internetwork 110 is the Internet, and the World Wide Web provides a system for interconnecting clients 102 and servers 104 through the Internet 110.

An exemplary client 102 includes the conventional components of a client system, such as a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as modem, digital subscriber line (“DSL”) card, cable modem, network interface card, wireless network card, or other interface device capable of wired, fiber optic, or wireless data communications. One example of such a client 102 is a personal computer equipped with an operating system such as Microsoft Windows 95, Microsoft Windows NT, or Unix and its variants, along with software support for Internet communication protocols. The personal computer also includes a browser program, such as Microsoft Internet Explorer or Netscape Navigator, to provide a user interface for access to the Internet 110. Although the personal computer is a typical client 102, the client 102 may also be a workstation, mobile computer, Web phone, television set-top box, interactive kiosk, personal digital assistant, or other device capable of communicating over the Internet 110. As used herein, the term “client” is intended to refer to any of the above-described clients 102, and the term “browser” is intended to refer to any of the above browser programs or other software or firmware providing a user interface for navigating the Internet 110.

In one embodiment, the client 102 is an Internet enabled television set-top box, such as that sold by WebTV. In this embodiment, the client 102 may include, for example, a wireless keyboard and a wireless mouse, or some other graphical user interface device, communicating with the set-top box over an infrared communication link. Such a client 102 may be connected to the internetwork 110 through the cable television infrastructure, with a data back channel used for communication from the client 102 to the internetwork 110. An Internet point-of-presence may be established at a cable head-end, or at some other location within the cable television infrastructure. In this embodiment, navigation to an interactive product selector page may be similar to, or identical to, navigation as described below for any other client device. Alternatively, a separate interface and/or site may be provided. This may have particular applicability where, for example, a set-top box does not include software or hardware for receiving plug-ins and other supporting software that might be required to render a particular page.

One embodiment of a client 102 may be a Wireless Access Protocol (“WAP”)/Wireless Markup Language (“WML”) device. Such a client 102 may be connected to the internetwork 110 through a direct connection to a WAP/WML server that is configured to respond to WML requests with WML compatible content, or the client 102 may be connected to the internetwork 110 through a WAP/WML gateway that operates to translate content and requests between WAP/WML and HTTP forms. It will be appreciated that a WAP/WML client may have a lower data rate than other devices for connecting to the internetwork 110, and that a WAP/WML device may have other physical characteristics that differ from a personal computer client, such as a smaller screen size, limited audio output, and slower text input modalities. As such, separate content may be provided at an interactive product selector site for such a client 102.

An exemplary server 104 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic, and may include separate servers for different functions such as a database server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems. As used herein, the term “server” is intended to refer to any of the above-described servers 104.

Focusing now on the internetwork 110, the presently preferred embodiment is the Internet. The structure of the Internet 110 is well known to those of ordinary skill in the art and includes a network backbone with networks branching from the backbone. These branches, in turn, have networks branching from them, and so on. The backbone and branches are connected by routers, bridges, switches, and other switching elements that operate to direct data through the internetwork 110. For a more detailed description of the structure and operation of the Internet 110, one may refer to “The Internet Complete Reference,” by Harley Hahn and Rick Stout, published by McGraw-Hill, 1994. However, one may practice the present invention on a wide variety of communication networks. For example, the internetwork 110 can include interactive television networks, telephone networks, wireless data transmission systems, two-way cable systems, customized computer networks, interactive kiosk networks and automatic teller machine networks.

One embodiment of the internetwork 110 includes Internet service providers 108 offering dial-in service, such as Microsoft Network, America OnLine, Prodigy and CompuServe. It will be appreciated that the Internet service providers 108 may also include any computer system which can provide Internet access to a client 102. Of course, the Internet service providers 108 are optional, and in some cases, the clients 102 may have direct access to the Internet 110 through a dedicated DSL service, ISDN leased lines, T1 lines, digital satellite service, cable modem service, or any other high-speed connection. Any of these high-speed services may also be offered through one of the Internet service providers 108.

In its present deployment as the Internet 110, the internetwork 110 consists of a worldwide computer network that communicates using the well-defined Transmission Control Protocol (“TCP”) and Internet Protocol (“IP”) to provide transport and network services. Computer systems that are directly connected to the Internet 110 each have a unique IP address. The IP address consists of four one-byte numbers (although a planned expansion to sixteen bytes is underway with IPv6). The four bytes of the IP address are commonly written out separated by periods such as “209.67.50.253”. To simplify Internet addressing, the Domain Name System (“DNS”) was created. The DNS allows users to access Internet resources with a simpler alphanumeric naming system. A DNS name consists of a series of alphanumeric names separated by periods. For example, the name “www.mypersonaladvocate.com” corresponds to a particular IP address. When a domain name is used, the computer accesses a DNS server to obtain the explicit four-byte IP address.

To further define the resources on the Internet 110, the Uniform Resource Locator system was created. A Uniform Resource Locator (“URL”) is a descriptor that specifically defines a type of Internet resource along with its location. URLs have the following format: resource-type://domain.address/path-name where resource-type defines the type of Internet resource. Web documents are identified by the resource type “http” which indicates that the hypertext transfer protocol should be used to access the document. Other common resource types include “ftp” (file transmission protocol), “mailto” (send electronic mail), “file” (local file), and “telnet.” The domain.address defines the domain name address of the computer that the resource is located on. Finally, the path-name defines a directory path within the file system of the server that identifies the resource. As used herein, the term “IP address” is intended to refer to the four-byte Internet Protocol address, and the term “Web address” is intended to refer to a domain name address, along with any resource identifier and path name appropriate to identify a particular Web resource. The term “address,” when used alone, is intended to refer to either a Web address or an IP address.

In an exemplary embodiment, a browser, executing on one of the clients 102, retrieves a Web document at an address from one of the servers 104 via the internetwork 110, and displays the Web document on a viewing device, e.g., a screen. A user can retrieve and view the Web document by entering, or selecting a link to, a URL, such as “http://www.fhe.com,” in the browser. The browser then sends an http request to the server 104 that has the Web document associated with the URL. The server 104 responds to the http request by sending the requested Web document to the client 102. The Web document is an HTTP object that includes plain text (ASCII) conforming to the HyperText Markup Language (“HTML”). Other markup languages are known and may be used on appropriately enabled browsers and servers, including the Dynamic HyperText Markup Language (“DHTML”), the Extensible Markup Language (“XML”), the Extensible Hypertext Markup Language (“XHML”), and the Standard Generalized Markup Language (“SGML”).

Each Web document usually contains hyperlinks to other Web documents. The browser displays the Web document on the screen for the user and the hyperlinks to other Web documents are emphasized in some fashion such that the user can identify and select each hyperlink. To enhance functionality, a server 104 may execute programs associated with Web documents using programming languages such as Perl, C, C++, or Java. A server 104 may also use server-side scripting languages such as ColdFusion from Allaire, Inc., or PHP. These programs and languages perform “back-end” functions such as order processing, database management, and content searching. A Web document may also include references to small client-side applications, or applets, that are transferred from the server 104 to the client 102 along with a Web document and executed locally by the client 102. Java is one popular example of a programming language used for applets. The text within a Web document may further include (non-displayed) scripts that are executable by an appropriately enabled browser, using a scripting language such as JavaScript or Visual Basic Script. Browsers may further be enhanced with a variety of helper applications to interpret various media including still image formats such as JPEG and GIF, document formats such as PS and PDF, motion picture formats such as AVI and MPEG, and sound formats such as MP3 and MIDI. These media formats, along with a growing variety of proprietary media formats, may be used to enrich a user's interactive and audio-visual experience as each Web document is presented through the browser. The term “page” as used herein is intended to refer to the Web document described above, as well as any of the above-described functional or multimedia content associated with the Web document.

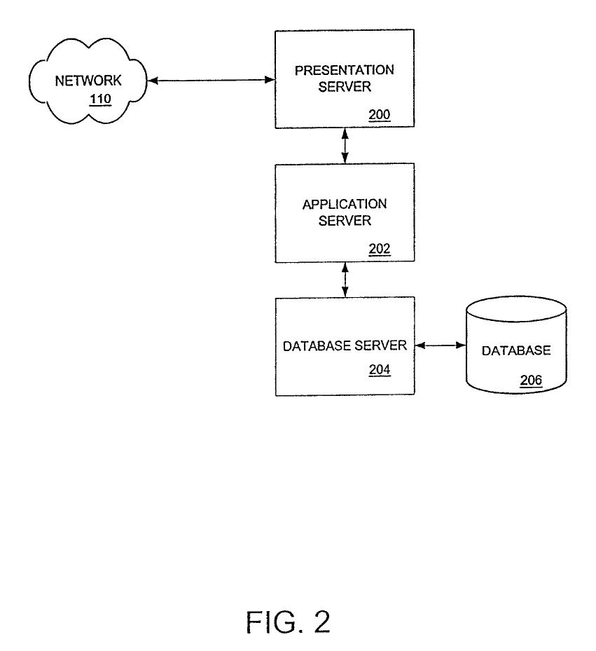

FIG. 2 shows a block diagram of a preferred embodiment of a server. In this embodiment, the server 104 includes a presentation server 200, an application server 202, and a database server 204. The application server 202 is connected to the presentation server 200. The database server 204 is also connected to the presentation server 200 and the application server 202, and is further connected to a database 206 embodied on a mass storage device. The presentation server 200 includes a connection to the internetwork 110. It will be appreciated that each of the servers may comprise more than one physical server, as required for capacity and redundancy, and it will be further appreciated that in some embodiments more than one of the above servers may be logical servers residing on the same physical device. It will further be appreciated that one or more of the servers may be at a remote location, and may communicate with the presentation server 200 through a local area or wide area network. The term “host,” as used herein, is intended to refer to any combination of servers described above that include a presentation server 200 for providing access to pages by the clients 102. The term “site,” as used herein, is intended to refer to a collection of pages sharing a common domain name address, or dynamically generated by a common host, or accessible through a common host (i.e., a particular page may be maintained on or generated by a remote server, but nonetheless be within a site).

The presentation server 200 provides an interface for one or more connections to the internetwork 110, thus permitting more than one of the clients 102 to access the site at the same time. In one embodiment, the presentation server 200 comprises a plurality of enterprise servers, such as the ProLiant Cluster available from Compaq Computer Corp. Other suitable servers are known in the art and are described in Jamsa, Internet Programming, Jamsa Press (1995), the teachings of which are herein incorporated by reference. The server maintains one or more connections to the Internet 110, preferably provided by a tier one provider, i.e., one of the dozen or so national/international Internet backbones with cross-national links of T3 speeds or higher, such as MCI, UUNet, BBN Planet, and Digex. Each enterprise server preferably runs the Microsoft Windows NT operating system, with a “front end” written in Microsoft Active Server Page (“ASP”), or some other programming language or server software capable of integrating ActiveX controls, forms, Visual Basic Scripts, JavaScript, Macromedia Flash Technology multimedia, e-mail, and other functional and multimedia aspects of a page. Typically, the front end includes all text, graphics, and interactive objects within a page, along with templates used for dynamic page creation.

A client 102 accessing an address hosted by the presentation server 200 will receive a page from the presentation server 200 containing text, forms, scripts, active objects, hyperlinks, etc., which may be collectively viewed using a browser. Each page may consist of static content, i.e., an HTML text file and associated objects (*.avi, *.jpg, *.gif, etc.) stored on the presentation server 200, and may include active content including applets, scripts, and objects such as check boxes, drop-down lists, and the like. A page may be dynamically created in response to a particular client 102 request, including appropriate queries to the database server 204 for particular types of data to be included in a responsive page. It will be appreciated that accessing a page is more complex in practice, and includes, for example, a DNS request from the client 102 to a DNS server, receipt of an IP address by the client 102, formation of a TCP connection with a port at the indicated IP address, transmission of a GET command to the presentation server 200, dynamic page generation (if required), transmission of an HTML object, fetching additional objects referenced by the HTML object, and so forth.

The application server 202 provides the “back-end” functionality of the Web site, and includes connections to the presentation server 200 and the database server 204. In one embodiment, the presentation server 200 comprises an enterprise server, such as one available from Compaq Computer Corp., running the Microsoft Windows NT operating system. The back-end software is preferably implemented using pre-configured e-commerce software, such as that available from Pandesic, to provide back-end functionality including order processing, billing, inventory management, financial transactions, shipping instructions, and the like. The e-commerce software running on the application server 202 includes a software interface to the database server 204, as well as a software interface to the front end provided by the presentation server 200.

The database server 204 may be an enterprise server, such as one available from Compaq Computer Corp., running the Microsoft Windows NT operating system and software components for database management. Suitable databases are provided by, for example, Oracle, Sybase, and Informix. The database server 204 also includes one or more databases 206, typically embodied in a mass-storage device. The databases 206 may include, for example, sale item pricing information, mailing or e-mailing lists, purchase orders, customer information, product information, news items, and the templates used by the presentation server to dynamically generate pages. In operation, the database management software running on the database server 204 receives properly formatted requests from the presentation server 200, or the application server 202. In response, the database management software reads data from, or writes data to, the databases 206, and generates responsive messages to the requesting server.

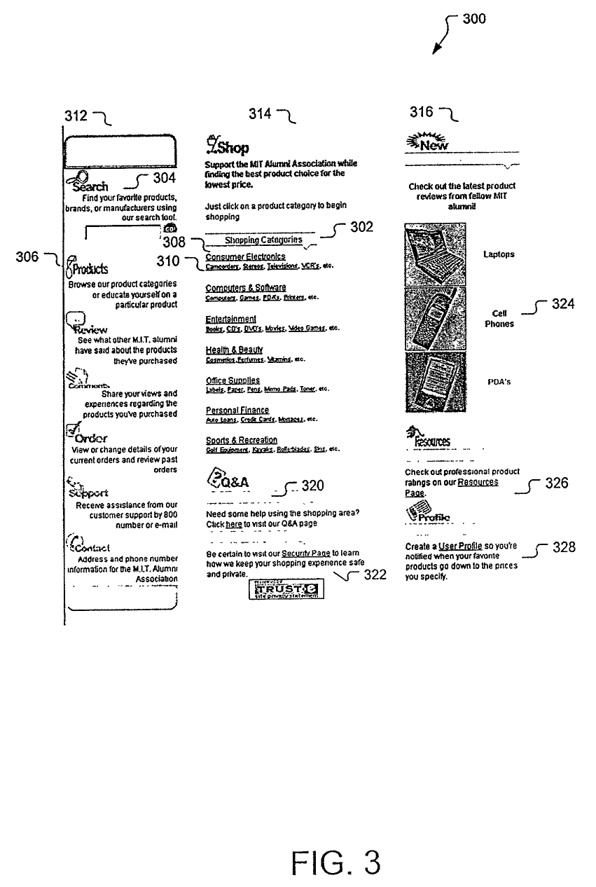

FIG. 3 shows a home page according to the principles of the invention. It will be observed that the home page 300 relates generally to the topic of shopping, and includes a number of categories 302, which may be shopping categories from which a user may select. A site search engine 304 may be provided, along with links 306 to product reviews, product support, a product browser, a comments site, an ordering site for ordering products and reviewing orders to same, and contact information for the business providing the home page 300, or a business associated with the home page 300. The links 306 may also include links to any other resources that may be of interest or use to a customer/consumer.

Each shopping category 308 may be subdivided into one or more sub-categories 310. For example, the shopping category 308 entitled “Consumer Electronics” may be subdivided into a number of sub-categories 310, such as “Camcorders”, “Stereos”, “Televisions”, “VCR's”, and the like. A category entitled “Computers & Software” may be subdivided into “Computers”, “Games”, “PDA's”, “Printers”, and the like. A category entitled “Entertainment” may be subdivided into “Books”, “CD's”, “DVD's”, “Movies”, “Video Games”, and the like. A category entitled “Health & Beauty” may be subdivided into “Cosmetics”, “Perfumes”, “Vitamins”, and the like. A category entitled “Office Supplies” may be subdivided into “Labels”, “Paper”, “Pens”, “Memo Pads”, “Toner”, and the like. A category entitled “Personal Finance” may be subdivided into “Auto Loans”, “Credit Cards”, “Mortgages”, and the like. A category entitled “Sports & Recreation” may be subdivided into “Golf Equipment”, “Kayaks”, “Rollerblades”, “Skis”, and the like. For each category, an “etc.” category may be provided for miscellaneous products that do not fit into any of the named sub-categories.

The page 300 may include additional features for access from a client, such as a question and answer link 320, a security link 322 that provides additional information concerning security features for the site, quick links 324 to popular or helpful content within the site, resource links 326 to additional resources available, and a user profile link 328 that permits a user to create and edit a personal profile. It will be appreciated that the user profile may be optional, and that in one embodiment, no user profile is required for an interactive product selector according to the invention.

The page 300 may be divided into a number of panels, such as a first panel 312, a second panel 314, and a third panel 316, with each panel dedicated to some portion of content. According to the principles of the invention, each panel 312, 314, 316 may be separately accessed by a server, such that portions of the content of the page 300 may be updated without requiring a new page to be transmitted to the client. In one embodiment, panels are defined using HTML frames. In one embodiment, panels are defined divisions that communicate data and program controls between a client and a server using, for example, JavaScript functions.

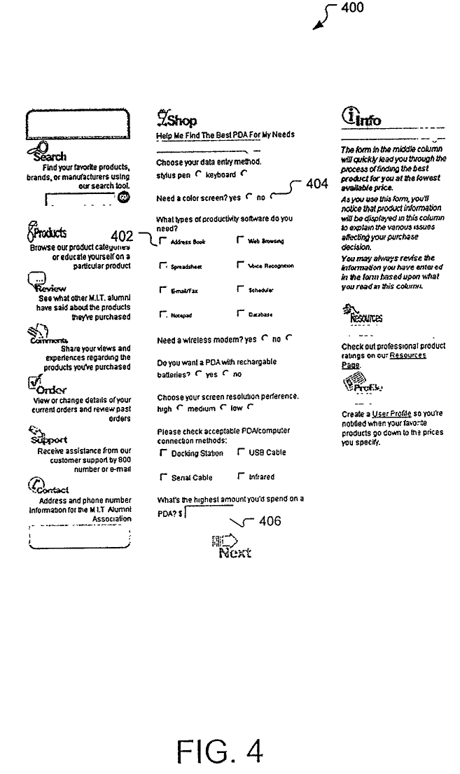

FIG. 4 shows a product selection page according to the principles of the invention. The product selection page 400 relates generally to the selection of features relating to a product, in this case, a personal digital assistant. The product selection page 400 may include features from the home page 300, such as those features shown in the first panel 312 and the third panel 316 of the home page 300. In one embodiment, the second panel 314 may be updated within the originally presented home page 300, thus providing the product selection page 400 without requiring any HTTP navigation to a new page from a client. The product selection page 400 may include one or more screen controls, such as check boxes 402, radio buttons 404 (which may provide for mutually exclusive selection or inclusive selection), and text boxes 406, each corresponding to a particular product feature. The features may be subjective, i.e., relating to stylistic features, general statements of functionality, and the like, or the features may be objective, i.e., requires an Infrared port, etc. The page 400 may also allow alphanumeric or range inputs, such as a user specified maximum price for the product.

In the exemplary product selection page 400 of FIG. 4, product criteria, or features, are displayed for a personal digital assistant (“PDA”). As seen in FIG. 4, a user may select a data entry method, including a stylus pen or a keyboard, optional color screen through a yes and a no radio button, required software, including an address book, a spreadsheet, e-mail/fax capability, a notepad or word processor, web browsing, voice recognition, a scheduler, and a database. A user may also select an optional modem (yes or no selection), optional rechargeable batteries (yes or no selection), screen resolution, including high, medium, or low, and a computer connection method, including docking station, serial cable, USB cable, or infrared connection. A user may enter a maximum price within a text box 406.

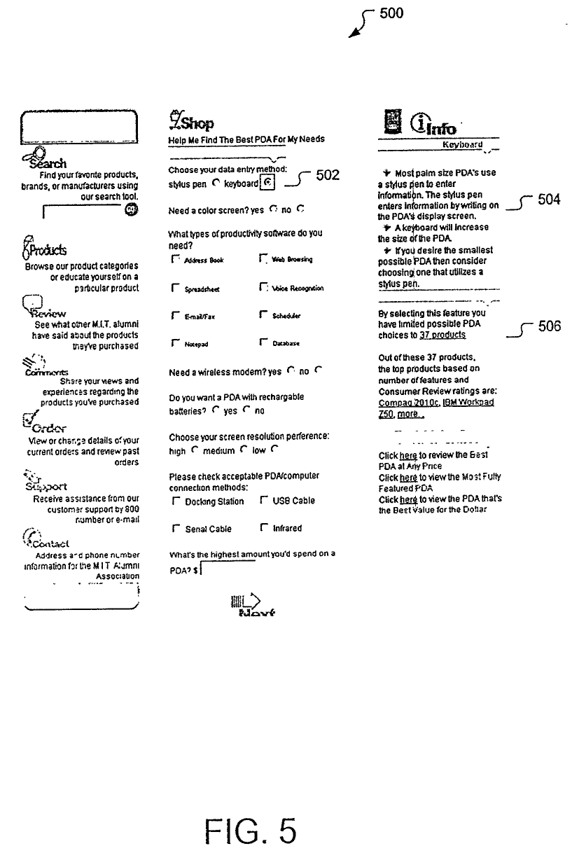

FIG. 5 shows a product selection page according to the principles of the invention. It will be observed that the page 500 of FIG. 5 is identical to the page 400 of FIG. 4, except that a radio button 502 labeled “keyboard” has been selected by a user. In response to this selection, information concerning keyboards (and a comparison to a second selection “stylus pen” for the same product criterion (“data entry method”)) is provided in a feature description panel 504 on the right side of the page 500. The text may include various comments, set of by bullets. For example, upon selection of the keyboard, the text in the feature description panel 504 may read:

Most palm size PDA's use a stylus pen to enter information. The stylus pen enters information by writing on the PDA's display screen.

A keyboard will increase the size of the PDA.

If you desire the smallest possible PDA then consider choosing one that utilizes a stylus pen.

In addition, the feature description panel 504, or a description sub-panel 506 may include information on a product set resulting from the user selection of a particular product criterion. For example, the desciption sub-panel 506 may state “By selecting this feature you have limited possible PDA choices to 37 products.” This text may include a link to a list of the products in the product set. The product set of 37 products may be further qualified, for example, according to product reviews, ratings, price, or the like. Additional selection assistance may be provided, such as an option to choose, for example, a best product at a specified price or at any price, the most fully featured product, or the best value per dollar. These selection options may include subjective or objective features.

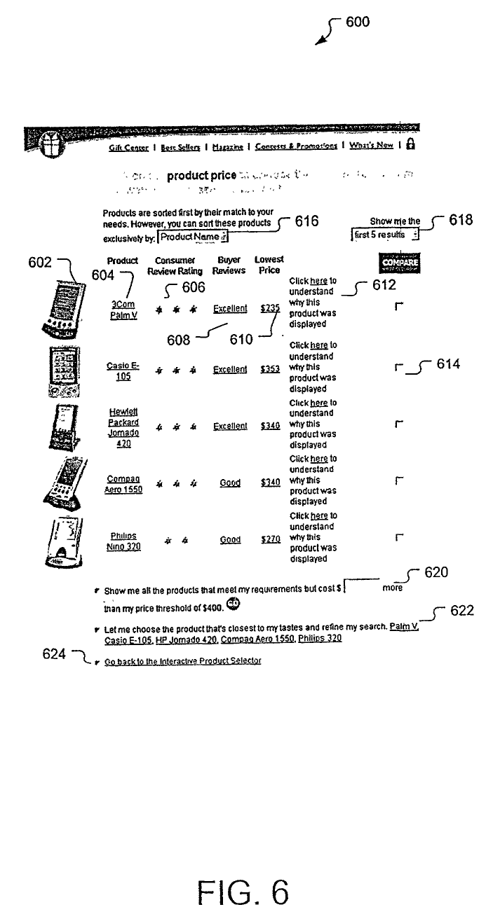

FIG. 6 shows a product set selected according to the principles of the invention. The product set may be presented as a product set page 600. The product set may be narrowed to a number of products meeting the product criteria specified in the preceding page, for example, the five personal digital assistants shown in FIG. 6. For each product, a picture 602 may be provided that shows the product. A product name 604 may be included, and the product name 604 may be hyperlinked to a description of the product. Further information may be provided for these products, such as a rating 606 that is provided by an independent, trusted organization or individual, such as Consumer Reviews. An additional rating 608 may be provided that is based on, for example, data collected directly from consumers who have purchased the product. A price 610 may be displayed for the product, which may be a lowest available price from one or more vendors of the product. An explanation link 612 may be included, which a user may select to view why a particular product was included in a product set. This may include a total score for the particular product, and representative statistics for other products in the category.

Other features may be included in the page 600. For example, comparison checkboxes 614 may be provided, so that a user may select a number of products in the product set for a side-by-side comparison. Products in the product set may be sorted according to a user-specified criterion 616, such as name, price, rating, or the like. A user may also specify the number of results to be displayed in each page using a number-of-results setting 618. A price adjustment 620 may be input by a user to raise or lower the product price as a product criterion. A user activate a product refinement link 622 to select a product that most closely suits the users criteria. Each product may be a separate hyperlink, activation of which adjusts a search to more closely match the criteria of the selected product. A back hyperlink 624 may be provided so that a user may return to the previous page. A link to a fulfillment page may also be provided, through which a customer may order a product that has been identified using the product selector. In one embodiment, the fulfillment page may be accessed by a hyperlink for the price 610.

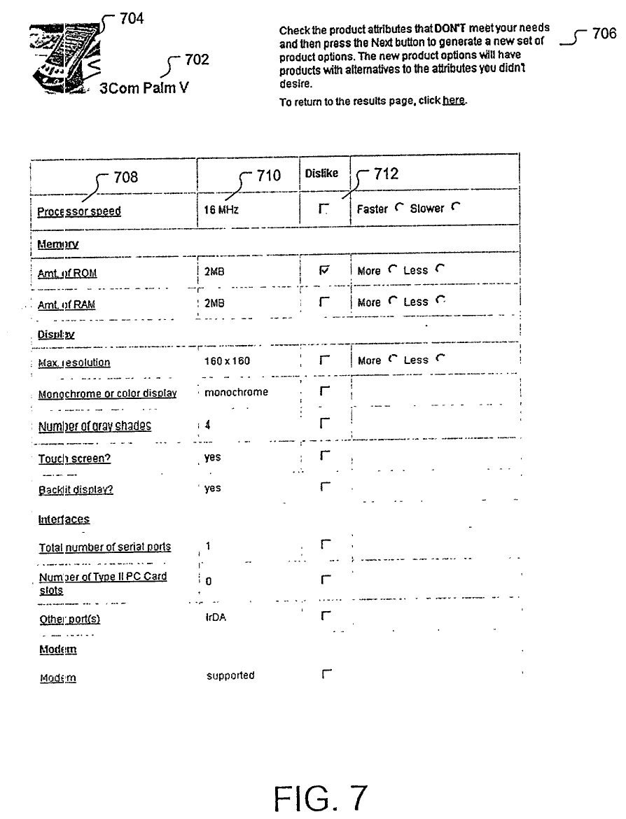

FIG. 7 shows a search refinement page according to the invention. The search refinement page 700 may be used to refine a product selection. The search refinement page 700 may be accessed through, for example, the search refinement link 622 of FIG. 6. The page 700 may include a name 702 and a picture 704 of a product used as a basis for refining the product selection. The page 700 may include instructions 706 for a user in refining a product selection. The page 700 may include a product criterion 708, such as a processor speed, a ROM size, a RAM size, a display resolution, a display type (monochrome, color, etc.; touch sensitive), a number a gray shades, number of serial ports, number and type of other ports, type of modem, and the like. For each product criterion 708, a value 710 may be displayed. For example, an amount of ROM may be two megabytes and an amount of RAM may be two megabytes. For each product criterion 708, a user taste 712 may be specified using a checkbox. The checkbox may signify that a user dislikes a value 710 for a product criterion 708, or the checkbox may signify that a user likes a value 710 for a product criterion 708. Where a range of values 710 is available for a product criterion 708, a user may specify a desired range 714. For example, a user may signify with a checkbox that the user dislikes a sixteen megahertz processor, and may indicate as well that a faster processor is desired.

Fuzzy logic may be used to generate a product set based upon the user requirements and subjective tastes submitted during product selection. A fuzzy logic set is a group of objects in which the distinction between members of the set and members not belonging to the set is not precise. Fuzzy logic allows objects to be assigned a degree of membership to a set rather than a simple assignment of group inclusion or exclusion. In other words, instead of determining whether x=y, fuzzy logic can make a determination that x is n degree of y. Alongside the capacity of fuzzy logic to describe the degree of set membership for an object, fuzzy logic can also make inferences based upon imprecise data.

For example, within an interactive product selector according to the invention, the user may be asked for a preference concerning a data input method for a handheld computer. The options may stylus and keyboard. The user may choose keyboard and then revise his selection to stylus after reading within the within a feature description panel that a keyboard increases the size of a handheld computer. Hence, a tradeoff has been made. The system, however, when producing a product set, will rank products with a stylus highest, followed by handheld computers that have a screen-based rendering of a keyboard that is used in conjunction with a stylus. The handheld computer would still be small, smallness being an inferred preference given that the user revised his product criterion selection based upon the information received during product selection, yet still have a keyboard feature which was the preference captured during the initial criterion selection. Handheld computers that have only a traditional keyboard may be ranked lowest.

Using fuzzy logic, a system according to the invention may analyze all of the potential members of the product set and create a product set optimized to the user's needs and subjective tastes as well as the limitations of available products. It will be appreciated that fuzzy logic may be applied to a number of product selection steps to optimize a product set. For example, criteria may be weighted according to the order in which they are selected, whether they have been changed, how they have been refined in the search refinement page 700, what information was provided to a user before selections were changed, and any other information that might be gathered from a user during a user selection process. By gathering data in this manner, a highly optimized product set may be obtained without requiring, for example, a user profile or explicit trade-offs that might otherwise interfere with a user's selection experience.

For example, an embodiment of the methods and systems of the invention can include a Fuzzy Logic Engine (FLE) that can evaluate a user requirements against available products or services to generate product or service recommendations most closely matching the user requirements. Those with ordinary skill in the art will recognize that the use of the word user, consumer, etc., for the illustrated embodiments, can be understood as information from a client as received by a server. In an embodiment, the FLE functionality can be implemented on the server to receive input from the client in the form of user requirements, and provide output to the client in the form of product recommendations as shall be discussed further herein, although such an example configuration of implementation is provided for illustration and not limitation.

In an embodiment, a FLE can determine user requirements by explicitly measuring the user's actions that can indicate a requirement of the user regarding the product, service, etc., and implicitly measuring and/or inferring user requirements by analyzing a user's information gathering and/or product or service requirement selection process.

Referring back to FIG. 6, it was explained that radio buttons and/or check box items can appear on the page and allow the consumer to select different options as presented by the radio buttons and/or check box items. Additionally, as previously indicated, different panels can appear as related to the radio button and/or check box options selected by the consumer. It is anticipated that some consumers or users may survey different radio button and/or check box options to gather information about a product, before selecting the “Show me all the products . . . ” option as shown in FIG. 6. In one embodiment of the FLE, therefore, it is anticipated that consumers may initially select those options most important to them, and select subsequent product features in a decreasing order of importance. The order of selections can therefore be an indication of the user's product/service requirements, and the relative importance of the requirements can be associated to the order in which the requirements are researched. Accordingly, in this embodiment of the FLE, product selections are classified as initial option selections, revised option selections, or submitted option selections.

Initial option selections, revised option selections, and submitted option selections can be defined with respect to a purchase decision question. For the illustrated embodiments, a purchase decision question (PDQ) can generally be defined as a question presented to the user or consumer via the web page, wherein the question is based on the item, service, product, etc., for which the consumer is seeking information. For example, referring back to FIG. 4, item 404, “Need a color screen?”, is a PDQ having a radio button format. Other illustrated PDQs are in the form of check boxes. In the illustrated embodiments, text boxes do not provide option information and are thus not considered within the definition of PDQs, although those with ordinary skill in the art will recognize that the invention herein is not limited to the format of the PDQs and other formats can be employed without departing from the scope of the invention.

In the FLE embodiment presented herein, in the case of radio buttons, initial option selections can be defined as those option selections (i.e., radio buttons selections) that the user initially selects within a purchase decision question. Additionally, in the case of check box selections, initial option selections can be those check boxes presented to the consumer by the system with a check or selection indicator, whereby the user initially removes the indicator and does not thereafter alter the indicator until the user selects “Show me all products . . . ” In an embodiment, initial option selections for check box PDQs can also include those options that are presented to the user as unchecked, wherein the user initially checks the option and thereafter does not alter the selection until the user selects “Show me all the products . . . ”

Similarly, in the FLE embodiment presented herein, submitted option selections can encompass the status of those radio button and/or check box options that are present when the consumer selects “Show me all the products . . . ” In the illustrated embodiments, the submitted option selections include information regarding checked and unchecked options when the “Show me all the products . . . ” selection is made.

Alternately, in the FLE embodiment presented herein, revised option selections can include those radio buttons and/or check boxes that are not the initial product selections and are not the submitted options selections, but were otherwise surveyed by the user between the initial option selection and the selection of “Show me all the products . . . ”

In the illustrated embodiments, for a user or consumer, the FLE creates multiple, individual fuzzy logic sets from the multiple PDQs and thereafter creates a master fuzzy set from the multiple individual sets. Although in an embodiment, each PDQ relates to an individual fuzzy set that may be a basis for the master fuzzy set, those with ordinary skill in the art will recognize that a master fuzzy set may be derived in many different ways and in some embodiments, all PDQs may not generate an individual fuzzy set or otherwise contribute to the master fuzzy set, wherein all such embodiments remain within the scope of the invention.

Individual fuzzy sets can be formed by ranking or otherwise assigning a membership grade to the PDQ options and selections; and in the illustrated embodiments, the submitted option for a given PDQ, that can otherwise be inferred to indicate a priority or highest option for the user, can be assigned the “highest” membership grade of 1.0, wherein membership grades can range between 0.0 and 1.0. In an embodiment, there are eleven membership grades between 0.0 and 1.0 in 0.1 increments, however such an example is merely provided for illustration and not limitation.

In the illustrated embodiments, if no option selections are made for a PDQ, all option selections associated with that PDQ are assigned a membership grade of 1.0.

Because an initial option selection can indicate a highly, if not most desired product/service feature for the user, notwithstanding additional information that may cause the user to otherwise compromise the feature, in the illustrated embodiments, initial option selections receive membership grades of 0.9.

In the illustrated systems, revised option selections can be assigned membership grades based on the order in which the revised option selections occurred with a PDQ. For example, if a user is provided with a radio button PDQ for camcorders that provides the user with options of “Hi-8”, “S-VHS”, “VHS-C”, and “Digital8”, and the user selects radio buttons for in the order provided herein, before pressing “Show me all the products . . . ”, the membership grades for this PDQ can be presented as shown in Table 1.

TABLE 1
Membership Grades for Camcorder Example

| Option Selection | Membership Grade |
|---|---|
| Hi-8 | 0.9 |
| (Initial Option | |
| Selection) | |
| S-VHS | 0.8 |
| (First Revised Option | |
| Selection) | |
| VHS-C | 0.7 |
| (Second Revised Option | |
| Selection) | |
| Digital8 | 1.0 |
| (Submitted Option | |
| Selection) | |

As Table 1 indicates, in the illustrated embodiments, the submitted option selection is assigned a membership grade of 1.0, the initial option selection has a membership grade of 0.9, and revised option selections are provided membership grades in decreasing value starting at 0.8 and decreasing by 0.1 for subsequent revisions. In an embodiment, the lowest membership grade is 0.0; and, if a user selects and option and later returns to that option, the illustrated systems can utilize the highest membership grade associated with the option, thereby disregarding subsequent selections of that option. For example, if a user shopping for camcorders is given options of “8 mm, VHS, VHS-C, S-VHS, Hi-8, Digital, and MiniDisc” in a radio button PDQ, and the user makes the following option selections: 8 mm, VHS, VHS-C, S-VHS, 8 mm, Hi-8, Digital 8, VHS, Hi-8, Digital 8, S-VHS, VHS, MiniDisc, and “Show me all the products . . . ”, for the illustrated system, membership grades can be initially assigned as shown in Table 2, and filtered to be provided a final membership grade assignment as shown in Table 3 according to the convention enumerated herein wherein the highest assigned membership grade attaches to the option selection.

TABLE 2
Initial Membership Grades for Camcorder

| Option Selection | Membership Grade |
|---|---|
| 8 mm | 0.9 |
| (Initial Option | |
| Selection) | |
| VHS | 0.8 |
| (First Revised Option | |
| Selection) | |
| VHS-C | 0.7 |
| (Second Revised Option | |
| Selection) | |
| S-VHS | 0.6 |
| (Third Revised Option | |
| Selection) | |
| 8 mm | 0.5 |
| (Fourth Revised Option | |
| Selection) | |
| Hi-8 | 0.4 |
| (Fifth Revised Option | |
| Selection) | |
| Digital 8 | 0.3 |
| (Sixth Revised Option | |
| Selection) | |
| VHS | 0.2 |
| (Seventh Revised Option | |
| Selection) | |
| Hi-8 | 0.1 |
| (Eighth Revised Option | |
| Selection) | |
| Digital8 | 0.0 |
| (Ninth Revised Option | |
| Selection) | |
| S-VHS | 0.0 |
| (Tenth Revised Option | |
| Selection) | |
| VHS | 0.0 |
| (Eleventh Revised | |
| Option Selection) | |
| MiniDisc | 1.0 |
| (Submitted Option | |
| Selection) | |

TABLE 3
Finalized/Filtered Membership Grades for
Camcorder Example of Table 2

| Option Selection | Membership Grade |
|---|---|
| 8 mm | 0.9 |
| (Initial Option | |
| Selection and Highest | |
| Assigned Membership | |
| Grade) | |
| VHS | 0.8 |
| (Highest Assigned | |
| Membership Grade for | |
| VHS) | |
| VHS-C | 0.7 |
| (Highest Assigned | |
| Membership Grade for | |
| VHS-C) | |
| S-VHS | 0.6 |
| (Highest Assigned | |
| Membership Grade for S- | |
| VHS) | |
| Hi-8 | 0.4 |
| (Highest Assigned | |
| Membership Grade for | |
| Hi-8 of .4) | |
| Digital 8 | 0.3 |
| (Highest Assigned | |
| Membership Grade for | |
| Digital 8 of .3) | |
| MiniDisc | 1.0 |
| (Submitted option | |
| selection) | |

As Table 3 indicates, in the illustrated system FLE, the filtering process eliminates redundancy by promoting redundant option selections to the highest membership grade for that given option selection. As indicated by Table 3, for the illustrated system, the options of Hi-8 and Digital 8 cannot be promoted higher than the greatest values from Table 2 of 0.4 and 0.3 respectively, even though a membership grade of 0.5 is available.

For the illustrated embodiments, the derivation of a master fuzzy set from the individual PDQ fuzzy sets is a multiple step process. In the first step, membership grades for option selections are associated to product/service features within a given product/service category. In a second step, the membership grades assigned to the products/services can be scaled and averaged to provide a single membership grade for a product/service.

In the first step of creating a master fuzzy set, the features of the products/services can be analyzed or otherwise reviewed to identify those features consistent with the option selections. Once the product/service features are identified, the membership grades from the individual fuzzy sets can be associated to the features and the scaling and averaging step can be performed.

In the illustrated systems, a positive integer N can be designated as the number of PDQs presented to a user for a product/service. The illustrated FLE scales membership grades associated with a given product/service feature by a factor of (1/N) when the membership grade is less than 1.0. This scaling can be performed to provide a relative comparison between products/services having respectively greater numbers of attributes satisfying a consumer's selections, to products/services having respectively fewer numbers of consumer attributes wherein those fewer attributes may otherwise have comparatively greater fuzzy logic membership grades. Once the membership grades with a product/service's features are scaled, the membership grades for the product/service's features can be averaged to provide a single, master membership grade for the product/service. In the illustrated embodiment, membership grades are rounded to the nearest one-tenth.

For the illustrated FLE, products/services having a master fuzzy set membership grade of 1.0 satisfy all user requirements, while master fuzzy set membership grades between 0.1 and 0.9 represent products/services partially satisfying user requirements, and master fuzzy set membership grades of 0.0 indicate products/services that do not have any features that the user designated in the PDQs.

The illustrated systems° FLE provides the master fuzzy set membership grades to the user via the web page. The master membership grades can categorized and presented by degree of satisfying the user's product/service requirements, and wherein two or more products/services maintain equivalent master fuzzy set membership grades, in the illustrated systems, equal membership grade product/services can be distinguished by customer feedback ratings for the respective products. Those with ordinary skill in the art will recognize that there can be many methods of categorizing the master fuzzy set membership grades, and alternate methods of determining priority for multiple products/services with the same master membership grade, and the invention herein is not limited by such techniques or methods.

The illustrated systems present products/services with a master fuzzy set membership grade of 1.0 for the respective category of product, with an indication that the products satisfy all of the user requirements. For example, a statement indicating “The following products [services] meet all the requirements you specified:” can be followed by or otherwise associated with hyperlinks to the corresponding products/services web page, and/or images of the products/service that may also provide a hyperlink to the product/service web page, although such presentation is provided for illustration and not limitation. The presentation for the products/services satisfying all user requirements can be ordered by customer feedback/preference ratings. Similarly, products/services having a master membership grade between 0.1 and 0.9 can be presented to the user in descending order with an indication of partial satisfaction of user requirements, for example, “The following products [services] meet some of the requirements you specified:”. Once again, hyperlinks to associated web pages for ordering the products can be provided, with other product information including images, product/service feature presentation, etc.

The illustrated systems can also provide a message to a user when no products/services satisfy the user requirements in full or partially. In this instance, all respective master fuzzy set membership grades are 0.0, and the user can be presented a single message indicating, for example, that “No product [service] meets the requirements you specified.”

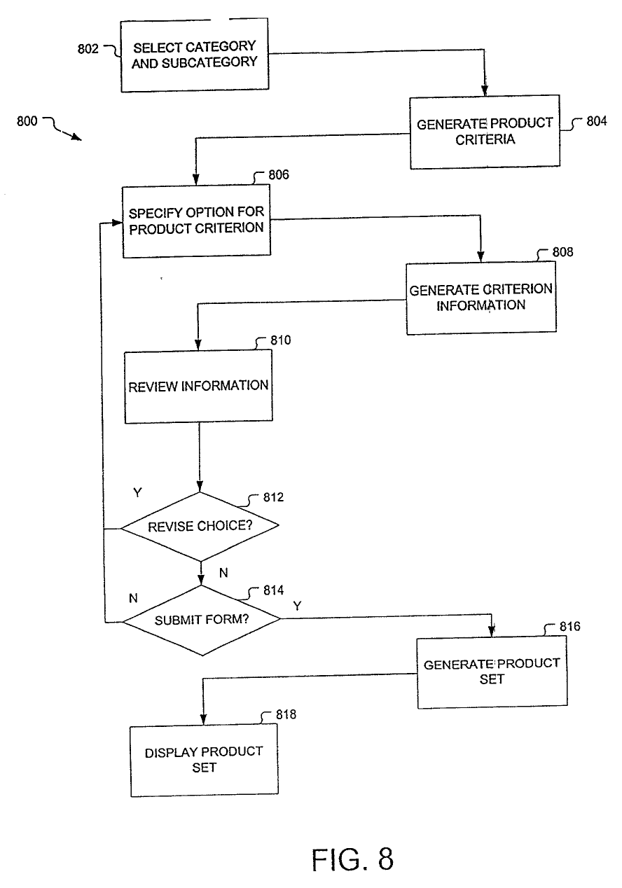

Those with ordinary skill in the art will recognize that the presentation of products/services and associated master fuzzy set membership grades can be coordinated with the information described herein with reference to FIG. 8. Additionally, although in an embodiment, the FLE can be implemented on a server with master fuzzy membership grade results and/or corresponding information presented to the client, although such configuration is provided for illustration and not limitation.

FIG. 8 shows a process for selecting products according to the principles of the invention. Those steps of the process 800 appearing on the left-hand side may occur on a client device. Those steps of the process 800 appearing on the right-hand side may occur on a server. It will be appreciated from the foregoing that, although this represents an embodiment of a client/server process according to the invention, other arrangements of client and server functionality are possible according to the invention. And specific steps of the following process may occur on a client, a server, or both, or the entire process may be usefully employed in a non-client/server environment.

In step 802 of the process 800, a user selects a category and, if appropriate, a subcategory. The category may be any category of good or service such as those described in this description. The selection may be transmitted to the server by explicit action of a user at the client, such as selecting a link from a list of possible categories.

In step 804, a server may generate product criteria in response to the selection of step 802. This may include accessing a product database where products and product information are stored. The product database may include, for each product category, one or more product criteria. For each product criterion, the database may include a question associated with the criterion, a plurality of options for the criterion, a control for selecting one of the plurality of options, selection guidance for each one of the plurality of options, and links to next criteria associated with each one of the plurality of options The question may include ASCII text, or some other representation of a question that is stored in a manner that may be presented to a human user at a client, and may prompt the user to select one of the plurality of options. The control may include code for rendering a control, or may specify any form of control that may be handled by the client, and may include, for example, a text box, a radio button, a drop-down list, one or more checkboxes, a scroll box, a slider, a dial, and the like. While use of these controls is known for, for example, Windows clients, other custom controls or other physical or graphical user interface controls may be defined for a client and used according to the principles of the invention. Selection guidance may include text of guidance for presentation to a user, along with display parameters such as a location within a page where the guidance is to be displayed, or the selection guidance may include a link or pointer to a location where the text and display parameters are stored. Other display parameters may include font size, formatting, borders, and the like. The links to other questions may be used to dynamically generate a series of questions in response to those criteria specified by a user at any time during the interactive product selection process. An example is provide below of information stored in a product database for a television:

| | |
|---|---|
| product category: | television |
| criterion: | screen size |
| question: | What size screen are you looking for? |
| options: | Under 13″, 13″-20″, 21″-28″, 29″-35″, |
| | over 35″ |
| control: | radio button |
| guidance: | [guidance for each option - see example |
| | below] |
| next criteria: | [links to proceeding criteria and |
| | questions for each option] |

A narrative form of the information stored in the product database is presented below as a more detailed example of a television selection process. All of the following information may be transmitted from a server to a client in a single transfer for subsequent interpretation by java script or some other event handler on the client side, or the information may be transmitted on an as need basis when, for example, particular options are selected:

[Under 13″, 13″-20″, 21″-28″, 29″-35″, over 35″] -
Checkbox
{Under 13″}Info-panel name = “Screen Size”

[symbol]

{13″-20″} Info-panel name = “Screen Size”

[symbol]

{21″-28″} Info-panel name = “Screen Size”

[symbol]

{29″-35″} Info-panel name = “Screen Size”

[symbol]

{Over 35″} Info-panel name = “Screen Size”

[symbol]

[HDTV, SDTV and standard] -Checkbox
{HDTV} Info-panel name = “TV Type”

[symbol]

{SDTV} Info-panel name = “TV Type”

[symbol]

{Standard} Info-panel name = “TV Type”

[symbol]

[Standard, Flat Screen] -Checkbox
{Standard} Info-panel name = “Screen Type”

[symbol]

{Flat Screen} Info-panel name = “Screen Type”

[symbol]

[PIP, Comb Filters, S-Video ready, Component Video A/V
Input/Outputs, Scan velocity modulation, 16:9 Aspect
Ratio] -Checkbox
{PIP} Info-panel name = “Added Features”

[symbol]

{Comb Filters} Info-panel name = “Added Features”

[symbol]

{S-Video} Info-panel name = “Added Features”

[symbol]

{Component Video A/V Input/Outputs} Info-panel name = “Added
Features”

[symbol]

{Scan Velocity Modulation} Info-panel name = “Added
Features”

[symbol]

{16:9 Aspect Ratio} Info-panel name = “Added Features”

[symbol]

[Stereo Sound, Surround Sound, Front A/V Jacks, Dual-
Antenna Inputs, Parental Lock/ V-Chip, Cable-ready] -
Checkbox
{Stereo Sound} Info-panel name = “Added Features”

[symbol]

{Surround Sound} Info-panel name = “Added Features”

[symbol]

{ Front A/V Jacks} Info-panel name = “Added Features”.

[symbol]

{ Dual-Antenna Inputs} Info-panel name = “Added
Features”

[symbol]

{Notch Filter} Info-panel name = “Added Features”

[symbol]

{Invar Shadow Masks} Info-panel name = “Added
Features”

[symbol]

{V-Chip and Parental Lock} Info-panel name = “Added
Features”

[symbol]

{Cable-ready TV} Info-panel name = “Added Features”

[symbol]

[Standard, Universal, Learning] -Checkbox
{Standard} Info-panel name = “Remote Type”

[symbol]

{Universal} Info-panel name = “Remote Type”

[symbol]

{Learning} Info-panel name = “Remote Type”

[symbol]

When information is provided for one of the options, other criteria and questions may be changed and/or reordered. For example, where question 1 above is answered by selecting a screen under 13″, questions 2, 3, and 6 may be eliminated completely. Question 4 may have modified options and be renumbered to question 2. Question 5 may have its options changed and may be renumbered to question 3. This reordering may be controlled by information stored within the product database, or may be controlled by application logic on the server side or the client side of the interactive product selector. Where the information to control question alterations is stored within the product database, it may be transferred to the client when a first question is transferred, or it may be transmitted when an option is specified at the client. The following is an example of the order of questions which may result from a user selection of screen under 13″:

[symbol]

[S-Video ready, Component Video A/V Input/Outputs,
16:9 Aspect Ratio] -Checkbox
{S-Video} Info-panel name = “Added Features”

[symbol]

{Component Video A/V Input/Outputs} Info-panel name = “Added
Features”

[symbol]

{16:9 Aspect Ratio} Info-panel name = “Added Features”

[symbol]

[Stereo Sound, Cable-ready] -Checkbox
{Stereo Sound} Info-panel name = “Added Features”

[symbol]

{Cable-ready TV} Info-panel name = “Added Features”

[symbol]

The product database may be realized using any database or relational database system, such as Oracle 8, SQL, MySQL, or any other database system. The client-side display may be micro-segmented to include display control for each of the criteria and questions in the product database. A group of the criteria and associated questions and options, may be displayed according to options selected by a user. The group of criteria and questions may be re-ordered, or questions may be removed from the display, or added to the display to produce a new group of criteria. Control of which questions are displayed may be embedded within a page on the client-side, or control of which questions are displayed may be provided by the server and passed to, for example, JavaScript event handlers on the client side. Control may be directed by specifying an ordered list of questions, with display of the questions handled autonomously by the page, or control may be directed by specifying which questions should be visible and where they should appear within the page.

Returning to the process 800 of FIG. 8, once product criteria have been generated in step 804, the process 800 may proceed to step 806 where a user may specify an option for a product criterion. This may be performed using, for example, the control and options provided from the product database. An option may also be presented to a client as, for example, a hyperlink.

When a user specifies an option, the process 800 may proceed to step 808 where criterion information is generated for the option. In an embodiment where selection guidance has been transmitted to the client, this step may include displaying the selection guidance. Where selection guidance information resides on the server within the product database, the page in which the product criterion and options are displayed may generate a request to the server for the selection guidance. The selection guidance information may then be transmitted from the server to the client where it may be placed in a panel within the page.

Additional information may be generated in response to an option specified in step 806. For example, a product set may be dynamically maintained, and the number of products within the product set may be updated in the page each time that an option is specified or revised for a product criterion. In this manner, a user may continue specifying options until the user determines that a manageable number of products are in the product set, for example, a sufficiently small number of products for the user to review each product of the product set individually. As described herein, the product set may also be revised through an application of fuzzy logic to the options specified and the order or manner in which they were specified and/or revised, including the implementation, for example, of the FLE presented herein.

In step 810, a user at the client may review information for an option. Upon reviewing information for the option, such as the selection guidance information, the user may choose to revise the choice, as shown in step 812, and return to step 806 where a new option is specified for the product criterion. The user may then submit the selection options, as shown in step 814. If the user does not submit the form, the user may specify an option for a different product criterion, or revising any existing options until the user is ready to submit the form. It will be appreciated that the form submitted in step 814 may be an HTML form, or any other data structure or protocol that may be used to transmit information from a client to a server, or to a different process on the client.

During the process 800, each option specified, and each revision of an existing option selection, may be stored and processed to more precisely adapt a product set to a particular user. For example, when an option is specified, application logic at the client or at the server may assign a priority to the option, as well as to predetermined other options that may relate to the selected option. The application logic may also assign priorities to one or more other features which are not available as explicit option selections, but which may be inferred from an option selection or selections, such as a preference for a product size or style. As indicated previously, these priorities may be used in a fuzzy logic, such as the FLE presented herein, or other system to revise the product set. Further, where an option is revised, the application logic may reduce the weight of the previous option rather than deterministically removing all products with the previous option from the product set. In an alternative embodiment, the application logic may infer that the previous option is disliked by a user, and apply a strong negative weight to the previous option, such that products with options similar to the previous option are also removed from a product set. Any such weighting or other decision-making may be implemented in the application logic used to generate a product set.

When a form is submitted in step 814, a product set may be generated, as shown in step 816. It will be appreciated that not all product criteria need to be specified for a form to be submitted. For example, a user may specify only those options that are important to the user, or the user may continue to specify options until the number of products in the product set drops below some number. Generating a product set according to step 816 may include collection of information for presentation at the client, such as product reviews, product ratings, prices, and any other information that may be relevant to a consumer of the product.

In step 818, the product set is displayed to a user. The display of a product set may include, for example, a page such as the page 600 shown in FIG. 6.

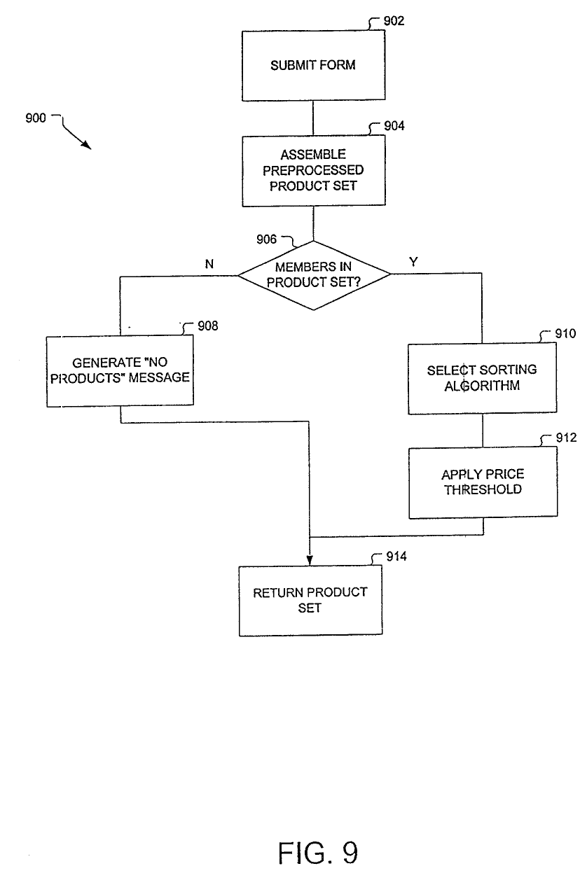

FIG. 9 shows a product set generation process according to the principles of the invention. As shown in FIG. 9, a product set generation process 900 may be used to prioritize and constrain a product set before the product set is provided for display to a user. In step 902, a form is submitted that includes all options specified by a user. The form may be, for example, an HTML form, or any other form or other medium for communicating data to the product set generation process 900.

In step 904, a preprocessed product set is assembled. The preprocessed product set may be generated by, for example, filtering a database of products with suitable queries.

In step 906, the preprocessed product set is checked to determine whether the set contains any members. If no members are contained in the preprocessed product set, then the process 900 may proceed to step 908 where a message is generated. The message may be text indicating that no products exist for the presently selected options, and may include formatting or other information used to control display of the message at a client device. If there are one or more products in the preprocessed product set, then the process 900 may proceed to step 910.

In step 910, a sorting algorithm is applied to the preprocessed product set to generate a sorted product set that establishes an order in which the product set will be displayed to a user. This may include a weighting of various options selected by a user, with each option being provided a weight according to, for example, an order in which the option was selected, or a fuzzy logic weighting using membership grades and/or scaling such as that described above. The weighted options may then be added together to generate a score for each product. The inputs to, or outputs from, the fuzzy logic system described above may be used during sorting of the preprocessed product set. Sorting may instead be performed according to other factors. For example, the product set may be sorted according to manufacturer, consumer rating, or price. In addition, several tiers of sorting may be applied, so that the list is sort first according to how well products have met user-specified options, e.g., by the score for each product, and then by price for those products having equal scores. It will be appreciated that the above examples are not exhaustive, and that other sorting algorithms or procedures may be used with an interactive product selector according to the principles of the invention.

In step 912, a price threshold may be applied to the sorted product set. The price threshold may be, for example, a price threshold entered into a textbox such as the textbox 406 shown in FIG. 4. The product set may be filtered to remove those products having prices above the price threshold. Other filtering mechanisms may be used to produce the product set. For example, the product set may be limited, by user specification or otherwise, to a maximum number of products. After the threshold has been applied, the product set may be returned, as shown in step 914. Where a user is at a remote, client device, this may include transmitting the product set over a network to the client device. In step 914, the product set may also be formatted for display by a client device.

It will be appreciated that, although each of the steps in FIGS. 8-9 may be associated with one of the user, the client system, and the server system, different portions of the process may be performed at different locations. Furthermore, certain steps may be added or omitted without departing from the scope of the invention. Each of the steps in FIGS. 8-9 may be implemented through one or more programming languages suitable to a networked, client/server environment, or to any other environment or platform on which the interactive product selector might be deployed. In one embodiment, the product selector uses HTML or XML pages containing Java Server Page and Java Script elements. The server system may be multi-tiered, including a database server, a business logic server, and a presentation server. The business logic may be implemented as Java objects.

While the pages and selection processes shown above have related to selection of consumer goods including personal digital assistants and televisions, it will be appreciated that different products, including any goods or services, may be selected using the above system. In one embodiment, a financial instrument selector may be provided. Categories of financial instruments may include, for example, equities, bonds, mutual funds, money market funds, and the like. A selector may be provided for choosing from among these categories using, for example, risk, taxation, rate of return, investment objectives, liquidation scenarios (e.g., retirement, home purchase, 5 years, 10 years, etc.), and the like. Within each category, further criteria may be provided. For example, with mutual fund selection, criteria may include sectors, historical rate of return, load or fees, size of fund, fund objectives, and the like. For equities, the selector may include criteria for price, price/earnings ratio, historical and/or projected growth rates, market capitalization, analyst ratings, and any other information, which might be used by an investor. For each selection, guidance may be provided concerning that selection, and changes in selections will also be tracked so that they may be used to provide product sets responsive to a user's interests or concerns. During the selection process, a second panel may be dynamically updated to show the user the number of selections conforming to the user's criteria.

In an embodiment of the systems and methods, an Inferential Logic Engine (ILE) can be implemented. In an embodiment, the ILE can be sets of logic rules, wherein a set of logic rules can be related to a specific subcategory. The logic rules can be designed and otherwise formulated by a subject matter expert for that subcategory, incorporated into the ILE, and modified accordingly thereafter as needed. The ILE can therefore dynamically alter the page according to interactions between the user and the page that trigger the ILE logic.

In an embodiment, the ILE responds to what may be defined herein as interaction events, wherein system behavior is accordingly altered as a result of the interaction event. For the purposes of this discussion, an interaction event can be defined as an event between a system user and the system, including for example, the selection of an option within an Interactive Product Selector (IPS) question, otherwise referred to herein as a Purchase Decision Question (PDQ).

In an embodiment, interaction events can be limited to what may be referred to herein as option selection patterns, wherein option selection patterns can be understood herein to be measured within an IPS category. An example IPS category can be, for example, Microwaves, Personal Digital Assistants, Coffee Makers, etc., although such examples are merely illustrative and not limiting; and, user's option selection patterns can be measured, in one embodiment of the ILE, across a single or multiple PDQs within an IPS category.

In an embodiment, an option selection pattern can be classified as sequenced or non-sequenced. For example, a user may select the following VCR options in order: 19-micron heads; video-head sensor; record fit; and commercial advance. Alternately, a non-sequenced option selection pattern can include, for example, multiple selections of DVD options including “multi-disc” and “portable.”

Because non-sequenced option selection patterns involve multiple selections, these non-sequenced option selections patterns can be mathematically represented using logical operators. For example, if a user selects options of A, B, C, and D, across a single or multiple PDQs within the same IPS category, potential non-sequenced option selection patterns can be represented utilizing logical operators such as AND, OR, NOT, UNION, and INTERSECT, in combination with priority operators such as “)” and “(”, although such logical and priority operators are provided merely for illustration and not limitation. For example, option selection patterns can be represented as “A AND B AND C”, “A AND D”, “A OR B”, “NOT (A AND C)”, “(A OR D) UNION (B AND C)”, or “(A AND B AND C) INTERSECT (D OR A).” In an embodiment, non-sequenced option selection patterns can be named or otherwise categorized, for example, “Risk Averse=(A AND B AND C) AND NOT (D OR E),” wherein such a designation may be related to Stocks, Bonds, Mutual Funds, etc., and wherein the selection of the stated options as provided by the relationship may be deemed to be an indication of a risk averse individual. The identification of a risk averse user can then cause the ILE to dynamically alter the page as provided further herein. As indicated previously, these categorizations, interpretations, and establishments of relationships can be developed initially by a subject matter expert and integrated into the IPS accordingly. These definitions, categorizations, interpretations, relationships, etc., can similarly be subsequently altered by a subject matter expert, system administrator, etc., as system performance is evaluated or otherwise measured. Additionally, the name of the relationship, etc., can similarly be altered accordingly after the initial establishment of the relationship. For example, the relationship initially defined as “Risk Averse” may later be changed to “Medium Risk.”

As part of the ILE, subject matter experts can provide logic for displaying or otherwise presenting new questions to a user based on option selection patterns. For example, if a user in an IPS category of “Televisions”, selects an option of “13 inches or smaller”, the system can respond with questions that could include “Do you want a handheld television?”, “Does the television require an anti-glare screen,”, and/or “Does the television require built-in speakers”. Alternately, in the above example, if an option of “24 inches or larger” was selected, the user would not be presented with a question regarding handheld televisions. The subject matter expert can therefore provide ILE rules to eliminate questions presented to a user based on option selection patterns.

In an embodiment, the ILE logic can include rules provided by a subject matter expert to associate fuzzy logic with the option selection pattern, wherein fuzzy logic can be implemented as provided by the fuzzy logic engine (FLE) described herein. For example, rules based on fuzzy set unions can incorporate fuzzy set information from multiple products. In an embodiment, as described with relation to the FLE disclosed herein, membership grades can be assigned to product features, and a master membership grade can be assigned to individual products, wherein the master membership grade can be based on the product's feature membership grades. Accordingly, in an embodiment, three different stock funds, for example, known as A, B, and C, can have fuzzy membership grades assigned respectively based on features of low load and capitalization, as shown in Table 4. In an embodiment, a fuzzy set union can be implemented by selecting the highest fuzzy membership grade for the desired features. For example, stock A's fuzzy membership union for low load and small capitalization can be 0.7, while the fuzzy set union for stock B can be 0.8.

Alternately, fuzzy set intersections can be generated by selecting the minimum of associated fuzzy set membership grades. For the stocks of Table 4, the fuzzy set intersect of low load and small capitalization for stock A can be 0.4, while the fuzzy set intersect for stock C can be 0.5.

TABLE 4
FUZZY MEMBERSHIP SCORES FOR DIFFERENT STOCKS

| | Feature | | | |
|---|---|---|---|---|
| | | Small | Union of | Intersect of |
| | Low Load | Capitalization | Low Load and | Low Load and |
| | (Membership | (Membership | Small | Small |
| Stock | Scores) | Scores) | Capitalization | Capitalization |
| A | .7 | .4 | .7 | .4 |
| B | .3 | .8 | .8 | .3 |
| C | .6 | .5 | .6 | .5 |

In an embodiment, subject matter experts can establish derived measures for a product or service subcategory that can be based on option selection patterns and incorporated into the ILE. For example, if a user in the IPS category of Boomboxes selects options for high battery storage and water resistance, a subject matter expert can determine that such option selection pattern indicates a preference for extreme portability. A subject matter expert can cause the system to construct, compute, calculate, etc., a derived measure for this option selection pattern, wherein the derived measure for portability can be expressed as a ratio of boombox weight to volumetric dimension, although those with ordinary skill in the art will recognize that such an example is merely for illustrative purposes. In an embodiment, the subject matter expert can also provide an algorithm to attach or otherwise associate a fuzzy membership grade to a derived measure, wherein the fuzzy membership grade can be expressed and/or computed using the fuzzy logic intersect and union functions described herein, although other methods for computing a fuzzy logic membership grade for a derived measure can be practiced within the scope of the invention. As indicated previously, the fuzzy logic membership grades from a derived measure can be integrated into the master fuzzy set membership grade for the products or services of interest.

In an embodiment of the invention, a subject matter expert can further integrate the FLE and ILE by generating rules to eliminate products, services, etc., from a set of purchase alternatives provided to the user, based on option selection patterns. As indicated herein, purchase alternatives can be presented to a user based on master fuzzy set membership grades, while in an embodiment incorporating the ILE, the purchase alternatives can be further filtered before presentation to the user by analyzing the option selection pattern. For example, returning to the scenario of the boombox, the FLE may produce master fuzzy results that are non-zero for particular boombox items, but the option selection pattern can indicate that certain of those non-zero master membership grade boombox items are not appropriate for the user and therefore should not be displayed. Accordingly, in an embodiment employing a FLE and an ILE, a subject matter expert can also increase weights to certain options in a PDQ based on a option selection pattern, to thereby increase the fuzzy set membership grade. For example, in the FLE presented herein, although the maximum membership grade is 1.0 for the submitted option selection, such a grade can be increased by adjusting weights assigned to other option selections, to effectively decrease the fuzzy set membership grades assigned to the other option selections and increase the membership grade difference between a given option selection and other option selections. In an embodiment of the ILE, only one option selection membership grade can be altered. Those with ordinary skill in the art will recognize that an option selection membership grade can also be decreased.

Option selection patterns can also be responsible for the adjustment of master fuzzy membership grades by introducing a new category into the master fuzzy set computation. As an example, a user's option selection pattern can indicate a desire for durability, while none of the PDQs specifically mention or reference warranties, etc. Providing the system has a database, etc., having warranty information available to the ILE, a subject matter expert can allow the ILE to extract warranty information from an existing database, etc., assign or otherwise compute fuzzy logic membership grades to the warranty information for the different products according to a predetermined algorithm, and incorporate the warranty fuzzy logic information into the master fuzzy logic membership grade computation.

Although the methods and systems disclosed herein indicate a presentation of product or service to a user according to product rankings, model preference ratings, master fuzzy membership grades, combinations thereof, etc., the ILE can allow a subject matter expert to specify rules wherein the products or services presentation order on the page can be determined according to an option selection pattern. For example, the products or services can be presented by ascending or descending price, alternative item rating systems, combinations thereof, etc., as determined by rules established by a subject matter expert and incorporated into the ILE.

In an embodiment of the ILE, rules can be established by the subject matter expert wherein an option selection pattern can cause the system to advocate an accessory item. For example, a user investigating video games can be presented with an option for joysticks when appropriate. In an embodiment, an accessory page can immediately follow a results page. In the example provided herein, the system can be designed to provide a message on the results page that includes “Given your gaming interests, you should consider also buying a joystick. After selecting a video game, click on the accessories button to investigate joysticks.”

Those with ordinary skill in the art will recognize that a single option selection pattern can cause multiple inference behaviors. For example, a given option selection pattern can cause the introduction of new questions, elimination of existing questions, content changes of the page (infopanels), an increase in a fuzzy logic membership grade, and the computation and utilization of a derived measure.

Those with ordinary skill in the art will recognize that the systems and methods presented herein can be applied to products, services, etc., and therefore the use of the word “product”, “products”, etc., can be understood herein to include products and services of all types.

One advantage of the present invention over the prior art is the implementation of an inferential logic engine to allow subject matter experts to incorporate inferential logic to alter the page according to a user's options and/or selections.

What has thus been described are methods and systems for an inferential logic engine (ILE) for an interactive product selector. In an embodiment, the interactive product selector provides a user with purchase decision questions (PDQs) regarding a product/service specified by the user. Subject matter experts familiar with the specified product/service can survey the potential user responses to PDQs, and based upon the responses, establish inferences. User selections or responses can be represented logically, and a user's selections satisfying a given logical expression can cause the ILE modify the page presentation. In an embodiment, the ILE can be integrated with a Fuzzy Logic Engine (FLE), wherein inferential information can provide additional input to an existing FLE, or can filter the outputs of an existing FLE.

Many additional changes in the details, materials, steps and arrangement of parts, herein described and illustrated to explain the nature of the invention, may be made by those skilled in the art within the principle and scope of the invention. Accordingly, it will be understood that the invention is not to be limited to the embodiments disclosed herein, may be practiced otherwise than specifically described, and is to be understood from the following claims, that are to be interpreted as broadly as allowed under the law.

What is claimed is:

1. A method for interactively providing information on a page, comprising,
providing at least one question on the page,
receiving at least one response based on the questions,
evaluating the responses against at least one predetermined criterion,
changing the information on the page based on the evaluation.

2. A method according to claim 1, wherein evaluating the responses against the predetermined criteria further comprises creating inferences based on the responses.

3. A method according to claim 1, wherein evaluating the responses against predetermined criteria further comprises,
converting the responses to at least one logical expression, and,
characterizing the information based on the logical expressions.

4. A method according to claim 1, wherein changing the information on the page based on the evaluation further comprises,
identifying product information,
extracting a subset of the identified product information based on the responses, and,
presenting the subset of information on the page.

5. A method according to claim 1, further comprising generating at least one derived measure from the responses.

6. A method according to claim 5, further comprising inputting the derived measures to a fuzzy logic engine.

7. A method according to claim 5, further comprising assigning a membership grade to the derived measures.

8. A method according to claim 1, wherein changing the information on the page further includes,
identifying product information, and,
weighting membership grades associated to the product information by a fuzzy logic engine.

9. A method according to claim 8, further comprising filtering the membership grades based on the responses.

10. A method according to claim 1, further comprising, identifying new information based on the responses.

11. A method according to claim 10, further comprising providing at least one additional page based on the new information.

12. A method according to claim 1, further comprising, based on the responses, combining membership grades from a fuzzy logic engine.

13. A method according to claim 12, wherein combining membership grades further comprises an intersect of membership grades.

14. A method according to claim 12, wherein combining membership grades further comprises a union of membership grades.

15. A method according to claim 1, further comprising identifying the responses as sequenced or non-sequenced.
